(19) United States
(12) Patent Application Publication
(10) Pub. No.: US 2008/0291484 A1
(43) Pub. Date: Nov. 27, 2008

(54) DRIVER APPARATUS, SETTING CONTENT MANAGEMENT METHOD, SETTING CONTENT MANAGEMENT PROGRAM

(75) Inventors: Naoki Hoshino, Saitama-ken (JP); Yuko Kimoto, Kanagawa-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/753,612

(22) Filed: May 25, 2007

(51) Int. Cl. G06F 3/12

(52) U.S. Cl. 358/1.15

(57) ABSTRACT

To provide a technique that can improve visibility of the registered setting contents and contribute to improvement of operability in a driver apparatus that causes an image processing apparatus to execute plural functions executable in the image processing apparatus on the basis of setting contents registered for respective functions.

A driver apparatus that causes an image processing apparatus to execute plural functions executable in the image processing apparatus on the basis of setting contents registered for the respective functions includes a selected-function determining unit that determines, on the basis of an operation input of a user, a function for which display of the setting contents is requested among the plural functions, a setting-information acquiring unit that acquires setting information indicating the setting contents registered for the function for which it is determined by the selected-function determining unit that display of the setting contents is requested, and a display control unit that causes the image processing apparatus to display, as a list, information on setting information acquired by the setting-information acquiring unit in association with information on the function for which it is determined by the selected-function determining unit that display of the setting contents is requested.

### BACKGROUND OF THE INVENTION

1. Field of the Invention

The present invention relates to a technique for improving operability of a setting screen in a driver apparatus that causes an image processing apparatus to execute plural functions executable in the image processing apparatus on the basis of setting contents registered for the respective functions.

2. Description of the Related Art

Conventionally, there is known a driver apparatus that causes an image processing apparatus to execute plural functions executable in the image processing apparatus such as a print function and a scan function on the basis of setting contents registered for the respective functions.

When a user attempts to cause the image processing apparatus to execute a desired function, the conventional driver apparatus performs setting on setting screens corresponding to the respective functions and instructs the image processing apparatus to execute processing with the setting contents. There is also provided a driver apparatus that registers setting contents of desired contents (so-called favorite settings) in advance and causes an image processing apparatus to execute various functions using the registered setting contents when necessary in order to reduce a burden of setting operation on a user.

However, in the conventional driver apparatus, when the registered plural setting contents are displayed on a screen, usually, all the setting contents are displayed in a predetermine display area as a list without specifically distinguishing what kinds of functions the setting contents are registered for. It is difficult to discriminate which function each of the setting contents displayed as the list is set for. Thus, there is a problem in terms of operability.

### SUMMARY OF THE INVENTION

It is an object of an embodiment of the invention to provide a technique that can improve visibility of the registered setting contents and contribute to improvement of operability in a driver apparatus that causes an image processing apparatus to execute plural functions executable in the image processing apparatus on the basis of setting contents registered for respective functions.

In order to solve the problem, a driver apparatus according to an aspect of the invention is a driver apparatus that causes an image processing apparatus to execute plural functions executable in the image processing apparatus on the basis of setting contents registered for the respective functions. The driver apparatus is characterized by including a selected-function determining unit that determines, on the basis of an operation input of a user, a function for which display of the setting contents is requested among the plural functions, a setting-information acquiring unit that acquires setting information indicating the setting contents registered for the function for which it is determined by the selected-function determining unit that display of the setting contents is requested, and a display control unit that causes the image processing apparatus to display, as a list, information on setting information acquired by the setting-information acquiring unit in association with information on the function for which it is determined by the selected-function determining unit that display of the setting contents is requested.

A setting content management method according to another aspect of the invention is a setting content management method in a driver apparatus that causes an image processing apparatus to execute plural functions executable in the image processing apparatus on the basis of setting contents registered for the respective functions. The setting content management method is characterized by including a selected-function determining step of determining, on the basis of an operation input of a user, a function for which display of the setting contents is requested among the plural functions, a setting-information acquiring step of acquiring setting information indicating the setting contents registered for the function for which it is determined in the selected-function determining step that display of the setting contents is requested, and a display control step of causing the image processing apparatus to display, as a list, information on setting information acquired by the setting-information acquiring step in association with information on the function for which it is determined in the selected-function determining step that display of the setting contents is requested.

A setting content management program according to still another aspect of the invention is a setting content management program for causing a computer to execute management of setting contents in a driver apparatus that causes an image processing apparatus to execute plural functions executable in the image processing apparatus on the basis of setting contents registered for the respective functions. The setting content management program is characterized by causing the computer to execute a selected-function determining step of determining, on the basis of an operation input of a user, a function for which display of the setting contents is requested among the plural functions, a setting-information acquiring step of acquiring setting information indicating the setting contents registered for the function for which it is determined in the selected-function determining step that display of the setting contents is requested, and a display control step of causing the image processing apparatus to display, as a list, information on setting information acquired by the setting-information acquiring step in association with information on the function for which it is determined in the selected-function determining step that display of the setting contents is requested.

### DESCRIPTION OF THE DRAWINGS

FIG. 1 is a diagram showing a configuration of an image processing system including a PC (including a driver apparatus) 11 and an image processing apparatus 21 according to an embodiment of the invention;

FIG. 2 is an external perspective view for explaining an overview of the image processing apparatus 21 according to the embodiment;

FIG. 3 is a functional block diagram for explaining the PC (the driver apparatus) 11 according to the embodiment;

FIG. 4 is a diagram showing an example of a display screen of a display 11a in the PC 11;

FIG. 5 is a diagram showing an example of a portal screen P;

FIG. 6 is a diagram for explaining a standard print setting screen;

FIG. 7 is a diagram for explaining a customized setting screen;

FIG. 8 is a flowchart for explaining a flow of processing in the driver apparatus according to the embodiment;

FIG. 9 is a diagram showing an example of a confirmation screen for confirming whether setting contents of setting operation should be registered;

FIG. 10 is a diagram showing an example of list display of setting contents by a display control unit; and

FIG. 11 is a diagram showing an example of a display screen 906 for a list of registered setting contents corresponding to multi-setting.

### DESCRIPTION OF THE EMBODIMENTS

An embodiment of the invention will be hereinafter explained with reference to the drawings.

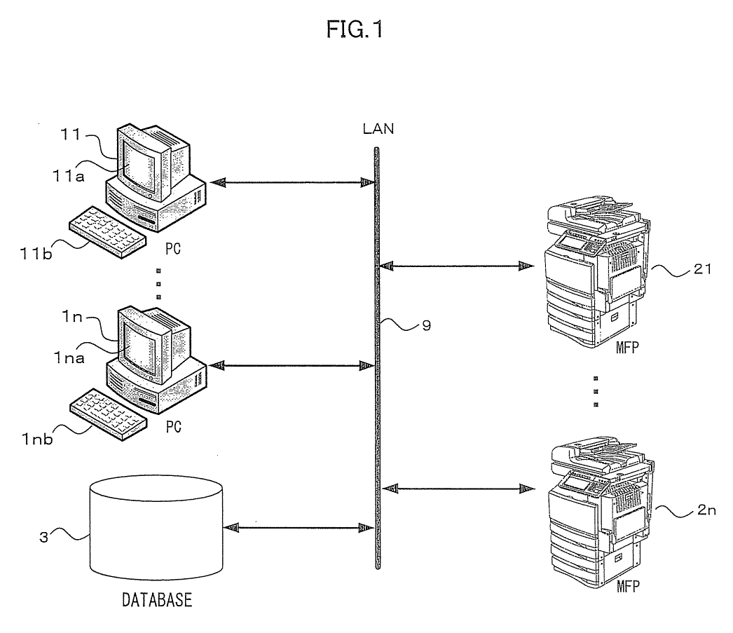

FIG. 1 is a diagram showing a configuration of an image processing system including a PC (including a driver apparatus) 11 and an image processing apparatus 21 according to this embodiment. In the image processing system shown in the figure, PCs (Personal Computers) 11 to 1n, image processing apparatuses 21 to 2n, and a database 3 are connected to be capable of communicating with one another via a telecommunication line such as a LAN 9.

Means for connecting the PCs 11 to 1n, the image processing apparatuses 21 to 2n, and the database 3 to be capable of communicating with one another is explained as the LAN here. However, the means is not limited to this and may be the Internet, a WAN, and the like (the means may be either wired or wireless). The PCs 11 to 1n are capable of performing various kinds of setting concerning an image processing function executable in the image processing apparatuses 21 to 2n and giving, for example, commands for execution of various processing functions to the image processing apparatuses 21 to 2n.

The commands and the like given to the image processing apparatuses 21 to 2n by the PCs 11 to in are performed by the driver apparatuses included in the PCs 11 to 1n on the basis of operation inputs performed by users, who look at setting screens displayed on displays 11a to 1na included in the PCs 11 to 1n, using operation inputting units (e.g., keyboards or mouses) 11b to 1nb. The example in which the displays and the operation inputting units are separately provided is cited here. However, the displays and the operation inputting units are not limited to this. For example, the functions of the displays and the operation inputting units may be realized by touch panel displays.

The database 3 has a role of a storage area that stores various kinds of setting information and the like used in the PCs 11 to 1n and the image processing apparatuses 21 to 2n.

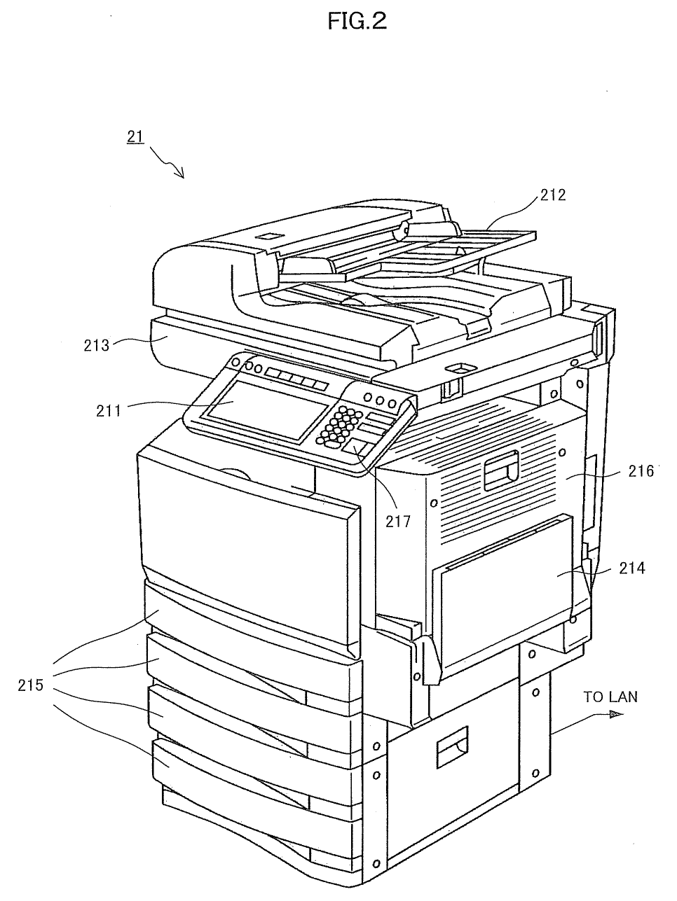

FIG. 2 is an external perspective view for explaining an overview of the image processing apparatus 21 according to this embodiment. Here, as an example, an example in which the image processing apparatus 21 is an MFP (Multi Function Peripheral) is cited.

The image processing apparatus 21 according to this embodiment includes an interface screen 211, an ADF (Auto Document Feeder) 212, an image scanning unit 213, a manual sheet feeding unit 214, sheet feeding cassettes 215, an image forming unit 216, and an authentication processing unit 217.

An example of operations of the image processing apparatus 21 according to this embodiment will be hereinafter briefly explained. When, for example, copy processing (predetermined image processing) is performed in the image processing apparatus 21, first, authentication processing for a user is performed by the authentication processing unit 217. Subsequently, an original set in the ADF 212 is automatically conveyed to a position for original scanning by the image scanning unit 213 on the basis of an operation input to the interface screen 211 by the user who has succeeded in the authentication processing. An image of the original conveyed in this way is scanned by the image scanning unit 213. A sheet feeding operation is performed by any one of the sheet feeding cassettes 215 and the manual sheet feeding unit 214 according to a sheet feeding method selected on the basis of the operation input to the interface screen 211. A sheet fed is conveyed to the image forming unit (an image processing unit) 216 and applied with image formation processing based on the image scanned by the image scanning unit 213. The copy processing is completed.

The interface screen 211 is constituted by, for example, a touch panel display. The interface screen 211 also has a role of an operation inputting unit that accepts an operation input of the user based on display contents on the interface screen 211.

The image processing apparatus 21 is capable of executing plural functions different from one another such as a “print function” of performing print processing on the basis of image data acquired by the image processing apparatus 21, a “facsimile function” of transmitting the image data acquired by the image processing apparatus 21 (image data scanned from an original, image data received from an external apparatus, etc.) to a desired destination by facsimile, a “scan function” of scanning an image of the original, and a “box function” of storing the image data scanned from the original by the “scan function” in the image processing apparatus 21 in a desired storage area. The “box function” is capable of selecting, as a data storage destination (a destination), at least any one of the PCs 11 to in and the image processing apparatuses 22 to 2n connected to the image processing apparatus 21 to be capable of communicating with each other. It is possible to realize a copy function by causing the image processing apparatus 21 to execute the “scan function” and the “print function” in combination.

As processing objects of the predetermined processing in the image processing apparatus 21, a sheet original, a book-like original, image data, and the like are cited as examples.

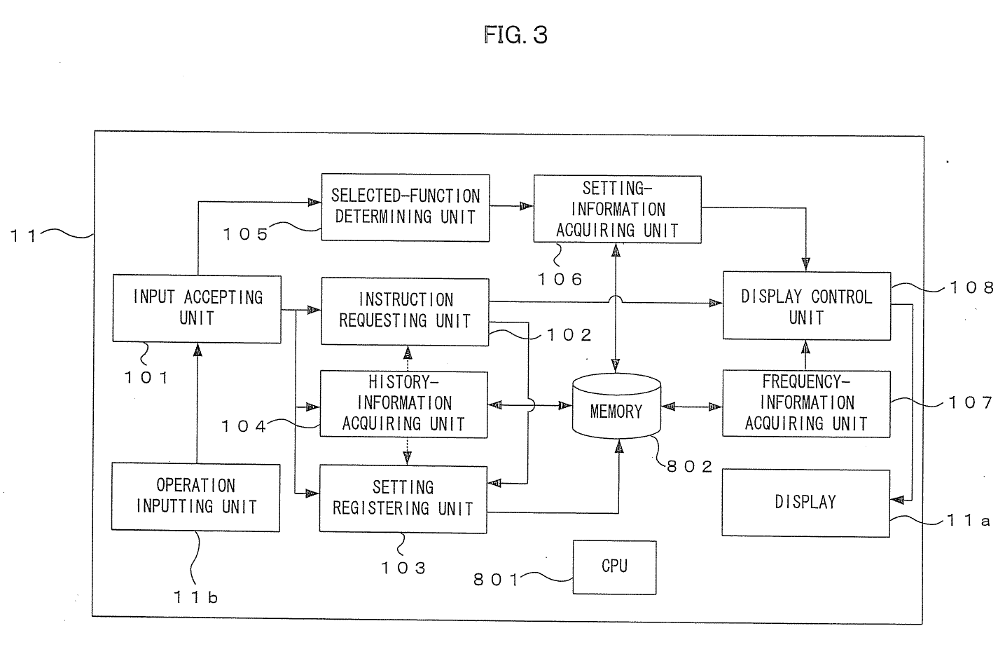

FIG. 3 is a functional block diagram for explaining the PC (the driver apparatus) 11 according to this embodiment. In this embodiment, the PCs 11 to in have the same components. The image processing apparatuses 21 to 2n also have the same components. It is possible to realize the image processing system according to this embodiment with any one of the image processing apparatuses 21 to 2n and any one of the PCs 11 to 1n. Thus, functions of the image processing system including the image processing apparatus 21 and the PC 11 will be hereinafter explained in detail as an example.

The PC 11 according to this embodiment causes the image processing apparatus to execute plural functions (e.g., the print function, the facsimile function, the scan function, and the box function) executable in the image processing apparatus on the basis of setting contents set in setting screens corresponding to the respective functions. The PC 11 according to this embodiment causes the image processing apparatus 21 to display plural setting screens for performing setting for each of the plural functions executable in the image processing apparatus 21, which are plural setting screens (a printer driver screen, a facsimile driver screen, a scanner driver screen, etc.) that can display plural setting items in the respective functions on the respective setting screens, such that selection of the setting screens can be switched.

Specifically, the PC 11 according to this embodiment includes an input accepting unit 101, an instruction requesting unit 102, a setting registering unit 103, a history-information acquiring unit 104, a selected-function determining unit 105, a setting-information acquiring unit 106, a frequency-information acquiring unit 107, a display control unit 108, a display 11a, an operation inputting unit 11b, a CPU 801, and a MEMORY 802.

The input accepting unit 101 accepts input information inputted to the operation inputting unit 11b by a user who performs setting operation for at least any one of the plural functions.

The instruction requesting unit 102 requests the user to give, using screen display on the display 11a, sound notification, or the like, an instruction on whether setting contents of the setting operation accepted by the input accepting unit 101 should be registered.

When the instruction indicating that the setting contents are registered is accepted by the instruction requesting unit 102, the setting registering unit 103 registers setting information based on the operation input accepted by the input accepting unit 101 in, for example, the MEMORY 802. A registration destination of the setting information is not limited to a storage area of the MEMORY 802 and may be an external apparatus connected to the PC 11 to be capable of communicating with each other such as the database 3. Consequently, the user can easily divert setting contents registered in the database 3 or the like when other PCs (e.g., the PCs 12 to 1n) are used as driver apparatuses.

The history-information acquiring unit 104 acquires information on a history of setting operation accepted by the input accepting unit 101 (information such as information concerning setting in what kinds of setting contents is performed and information concerning setting of a combination of what kinds of setting items is performed). The setting registering unit 103 registers, on the basis of the information acquired by the history-information acquiring unit 104, setting contents for which setting operation with the same contents is repeated (frequently performed redundantly) a predetermined number of times (e.g., five times) or more in a predetermined period (e.g., thirty days).

The selected-function determining unit 105 determines, on the basis of the operation input to the operation inputting unit 11b by the user, a function for which display of setting contents is requested among the plural functions.

The setting-information acquiring unit 106 acquires setting information indicating setting contents registered for the function for which it is determined by the selected-function determining unit 105 that display of the setting contents is requested.

The frequency-information acquiring unit 107 acquires information on a frequency of use of the registered setting contents for actual execution of functions (e.g., the number of times of use per a unit period) from log information stored in the MEMORY 802.

The display control unit 108 causes the PC 11 to display “information on the setting information” acquired by the setting-information acquiring unit 106 and “information on setting items to be set in the setting information” as a list in association with information on the function for which it is determined by the selected-function determining unit 105 that display of the setting contents is requested (a function name, an icon indicating the function, etc.).

The display control unit 108 allocates information on setting information to be displayed to display areas different for each of the functions and causes the PC 11 to display the information therein. The display control unit 108 causes the PC 11 to display, on the basis of the information acquired by the frequency-information acquiring unit 107, information on setting contents with a higher frequency of use to be located further on at least one of the left side and the upper side in a predetermined display area.

The CPU 801 has a role of performing various kinds of processing in the PC 11 and also has a role of realizing various functions by executing programs stored in the MEMORY 802. The MEMORY 802 is constituted by, for example a ROM or a RAM and has a role of storing various kinds of information (e.g., operation log information) and programs used in the PC 11.

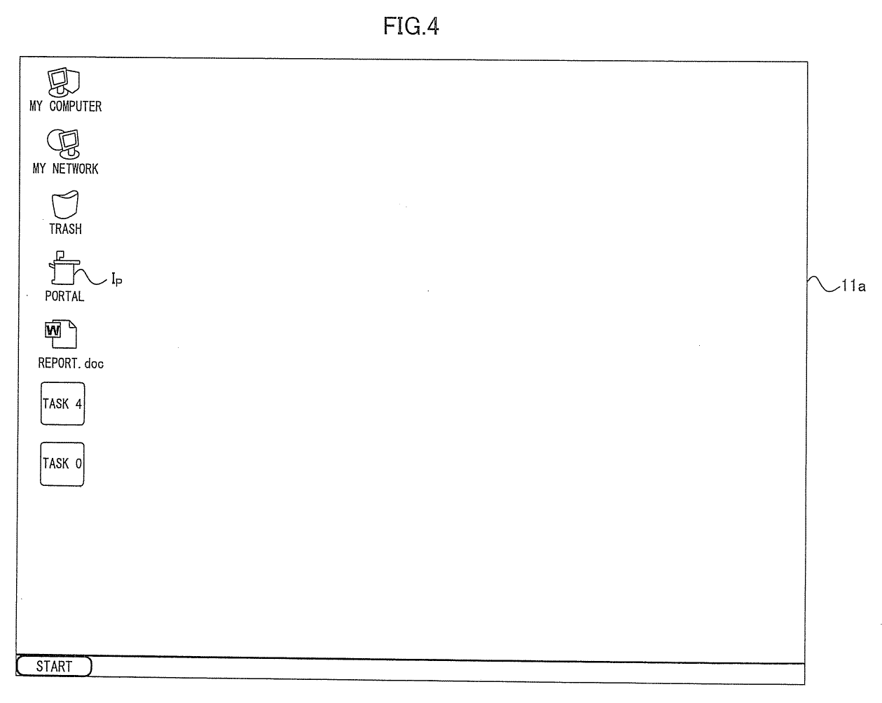

Operations of the driver apparatus according to this embodiment will be explained. First, a method of invoking the respective driver screens and the like will be explained using FIGS. 4 to 7.

FIG. 4 is a diagram showing an example of a display screen of the display 11a in the PC 11. On the display 11a, a “portal” icon Iₚ is displayed together with various icons such as “My Computer” and “My Network”.

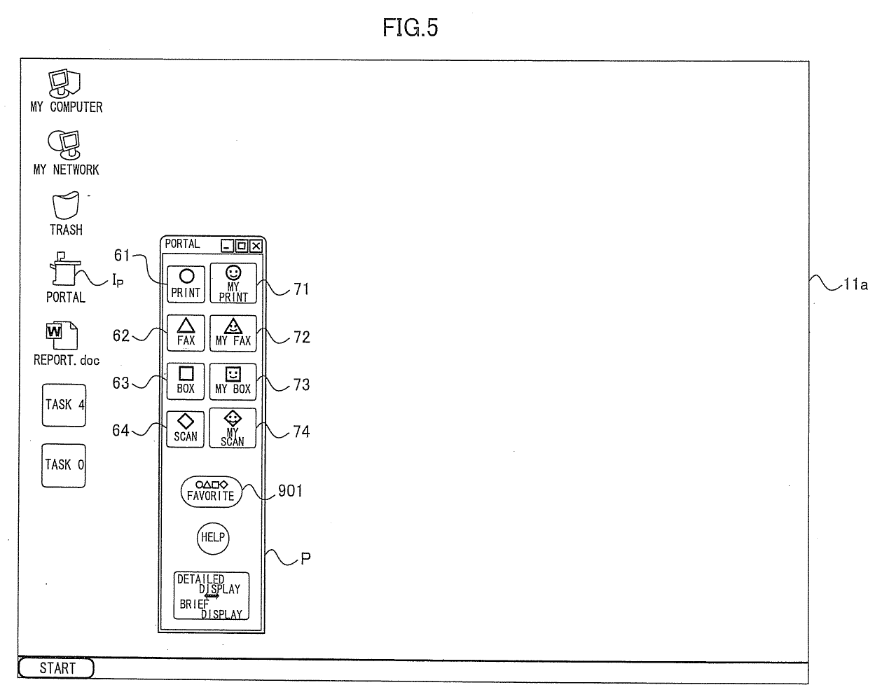

When the user selects this “portal” icon Iₚ with an operation input (double click, etc.) to the operation inputting unit 11b, a portal screen P shown in FIG. 5 is displayed in the screen of the display 11a. On the portal screen P, buttons 61 to 64 for opening setting screens (driver screens) for performing the conventional standard function setting, buttons 71 to 74 for opening my setting screens (customized driver screens) corresponding to respective functions that respective users can customize, and a “Favorite” button 901 for invoking a list of setting contents for respective functions registered in advance are displayed. In this way, on the portal screen P, it is clearly indicated that setting operation is also possible for functions other than the print function executable in the image processing apparatus 21.

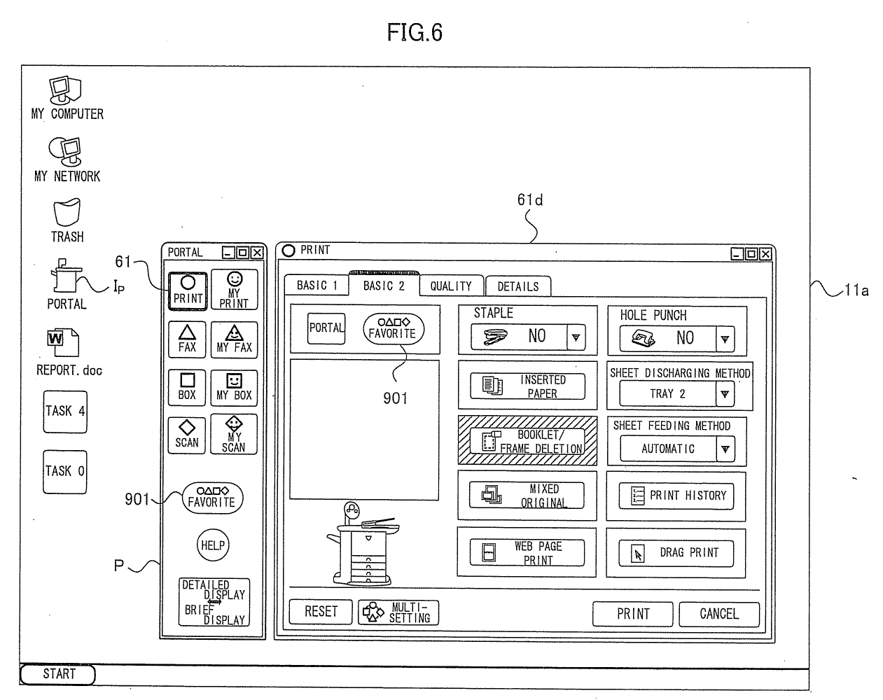

When the user desires to perform, for example, print setting on a standard setting screen for the print function, the user can display a standard print setting screen 61d shown in FIG. 6 by selecting the button 61 with the operation inputting unit 11b (a state in which a button or the like on the screen is selected is represented by surrounding the button with a thick line as shown in FIG. 6).

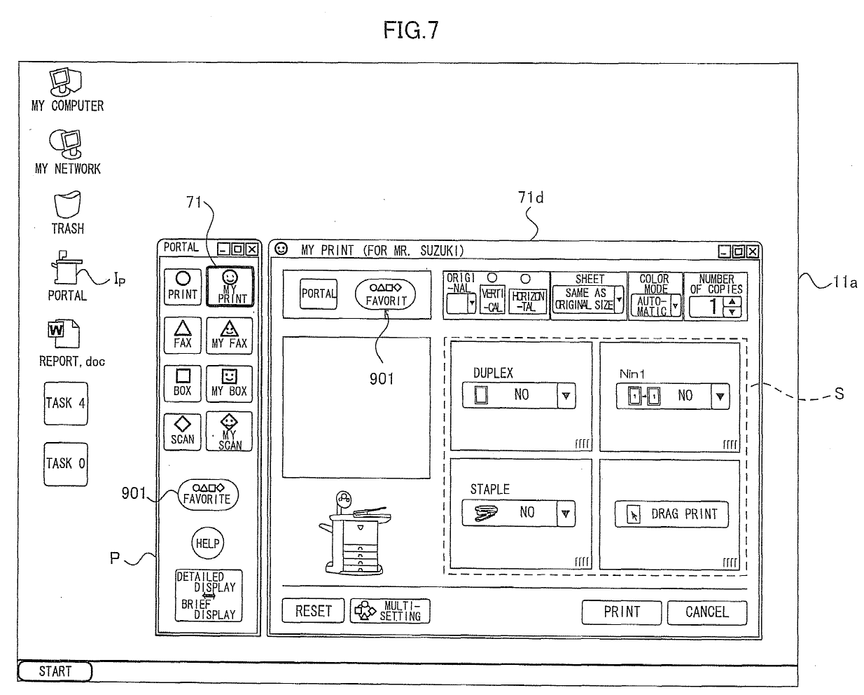

On the other hand, when the user desires to use a customizable print setting screen, the user selects the button 71 with the operation inputting unit 11b. Then, as shown in FIG. 7, a setting screen in which setting items (setting items that should be displayed in the setting screen) registered to be associated with the user in advance for the print function are arranged in a display area S is displayed. Here, on both the standard print setting screen shown in FIG. 6 and the customized setting screen shown in FIG. 7, the “Favorite” button 901 is always displayed regardless of setting states of the setting screens.

In this way, only setting items that should be displayed in the setting screen among the various setting items corresponding to the plural functions of the image processing apparatus are selectively displayed in the display area S of the setting screen. Consequently, it is possible to improve brief graspability of the various setting items at a glance and display the setting items on a screen and it is possible to provide an interface screen on which the user can easily perform setting.

The number of setting items displayed in the display area S at a time can be set to a predetermined number in default. However, the number of setting items may be arbitrarily set on the basis of an operation input of the user. A size of icon images and the like of the setting items displayed as a list in the display area S and a size of characters indicating the respective setting items are changed according to the numbers of the setting items displayed (e.g., when the number of items is small, an area used for one item is increased to increase the character size). This makes it possible to further contribute to improvement of visibility of the respective setting items.

As described above, even different setting items generally displayed in separate tabs in the printer driver and setting items usually located in deep hierarchies (e.g., setting items generally having low frequencies of use) are registered as display objects in the setting screen if frequencies of use of the setting items are high. This leads to improvement of visibility and operability in setting work.

A procedure for registering setting items in display objects using the operation inputting unit 11b will be explained.

In the state in FIG. 6, when the user selects the “My Print” button 71 in the portal screen P, a print setting screen 71d and the standard print setting screen 61d are simultaneously displayed.

The user drags, with a mouse or the like, a setting item (here, “staple” is selected) that the user desires to display in the display area S in the print setting screen 71d (desires to add to setting items of the setting screen for the user) out of the plural setting items displayed on the print setting screen 61d in this way, moves the setting item to the display area S in the print setting screen 71d, and drops the setting item in the display area S.

By performing the drag and drop operation described above, the user can register the desired setting item in the display objects in the display area S in the print setting screen 71d. This makes it possible to customize a setting screen with a higher degree of freedom.

In this embodiment, setting items that can be registered in the display objects in the display area S in the print setting screen 71d by the drag and drop operation are displayed with a light background color in the print setting screen 61d and setting items that cannot be registered (cannot be dragged and dropped) are displayed with a dark background color (see, for example, “booklet/frame deletion” in FIG. 6). Consequently, the user can visually grasp the setting items that can be registered as display objects in the display area S in the print setting screen 71d.

Setting operation using the setting screen described above and processing for registering setting contents will be explained.

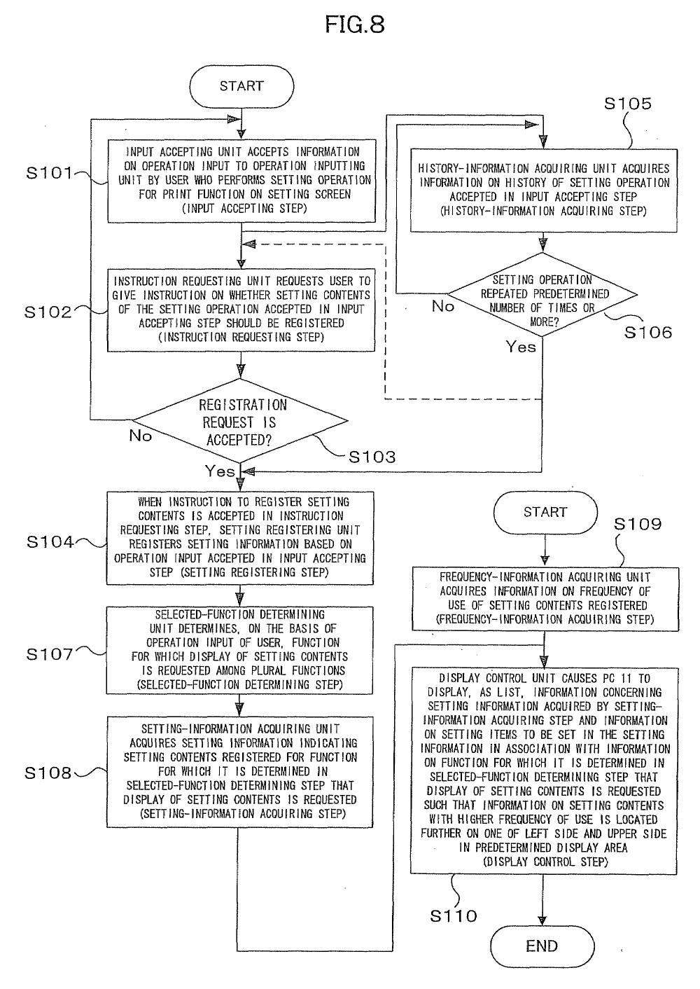

FIG. 8 is a flowchart for explaining a flow of processing in the driver apparatus according to this embodiment. An example of a flow of processing in registering setting contents for the print function will be explained here.

The input accepting unit 101 accepts information on an operation input to the operation inputting unit 11b by the user who performs setting operation for the print function, for example, on the setting screen shown in FIG. 7 (an input accepting step) (S101). Here, as an example, it is assumed that contents of the setting operation by the user are contents concerning “duplex printing”, “N in 1 printing”, and “staple processing”.

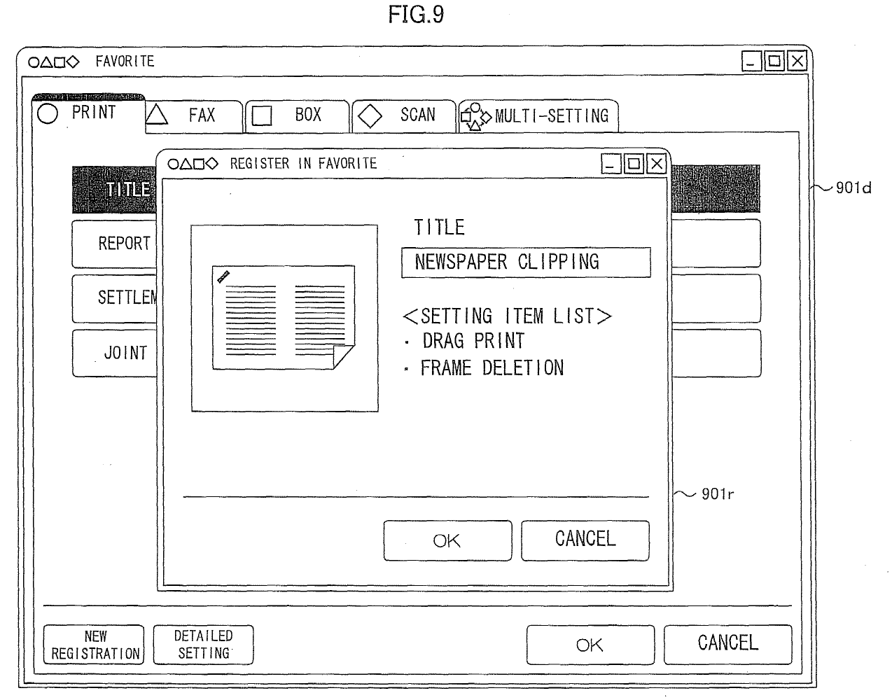

Subsequently, the instruction requesting unit 102 requests, using a confirmation screen shown in FIG. 9, the user to give an instruction on whether setting contents of the setting operation accepted in the input accepting step should be registered (an instruction requesting step) (S102). For example, when setting operation for causing the image processing apparatus to execute predetermined processing such as a print operation is performed in the image processing apparatus, the instruction requesting unit 102 inquires, when execution of the setting contents is instructed, the user whether the setting contents should be registered as “favorite settings”. This makes it possible to simply and easily register setting contents with a high frequency of use and the like in normal setting operation for the image processing apparatus.

When an instruction to register the setting contents is accepted in the instruction requesting step (S103, Yes), the setting registering unit 103 registers setting information based on the operation input accepted in the input accepting step (titles given to the setting contents, names of setting items to be sets in the setting information, etc.) (a setting registering step) (S104).

The example in which contents of the setting operation immediately before execution of the print function are registered is cited here. However, registration of setting contents is not limited to this. It is also possible to perform a registration instruction in the confirmation screen in FIG. 9 by depressing the “Favorite” button 901 on the setting screen shown in FIG. 7 after performing setting operation for registering the setting contents.

It is also possible to acquire, in the history-information acquiring unit 104, information on a history of the setting operation accepted in the input accepting step (a history-information acquiring step) (S105) and, when the setting operation with the same contents is repeated in the setting registering step a predetermined number of times or more on the basis of the information acquired in the history-information acquiring step, register the setting contents. In the example shown in FIG. 9, setting contents concerning the “duplex printing”, the “N in 1 printing”, and the “staple processing”, which are the setting items to be subjected to the setting operation, are registered in the MEMORY 802 according to an operation input corresponding to a registration request (in the example shown in FIG. 9, according to input of a title and depression of the “OK” button).

Regardless of presence or absence of acceptance of an instruction in the instruction requesting step, the input may be automatically registered at a point when the input is accepted. According to the content of the history information acquired in the history-information acquiring step, the driver apparatus may proceed to registration processing through the instruction requesting step when the setting operation with the same contents is repeated (S106, Yes).

The selected-function determining unit 105 determines, on the basis of the operation input to the operation inputting unit 11b by the user, a function for which display of setting contents (favorite settings) is requested among the plural functions (a selected-function determining step) (S107). Here, as an example, it is assumed that the user performs a display request for the print function.

The setting-information acquiring unit 106 acquires setting information indicating the setting contents registered for the function for which it is determined in the selected-function determining step that display of the setting contents is requested (a setting-information acquiring step) (S108). Here, the setting-information acquiring unit 106 acquires ID information and the like for identifying the user from the authentication processing unit 217 and extracts and acquires setting contents registered in association with the ID information. Consequently, it is possible to extract only desired setting contents requested by respective users and display the setting contents as a list. It goes without saying that, when it is unnecessary to manage contents of the favorite settings for each of the users because of an installation environment and the like of the PC 11, the setting contents may be simply managed for each of the functions regardless of a user ID and the like.

The frequency-information acquiring unit 107 acquires, independently from the processing in S101 to S108, information on a frequency of use of the setting contents of the favorite settings registered (a frequency-information acquiring step) (S109). In other words, the frequency-information acquiring step only has to be executed at least prior to the display control step and may be executed before or after execution timing of the other steps (S101 to S108).

The display control unit 108 causes the PC 11 to display, as a list, information (characters, icons, etc. for representing the setting information on the screen) concerning the setting information (titles given to the setting contents, names of the setting items to be sets in the setting information, etc.) acquired by the setting-information acquiring step in association with information on the function for which it is determined in the selected-function determining step that display of the setting contents is requested (a display control step) (S110).

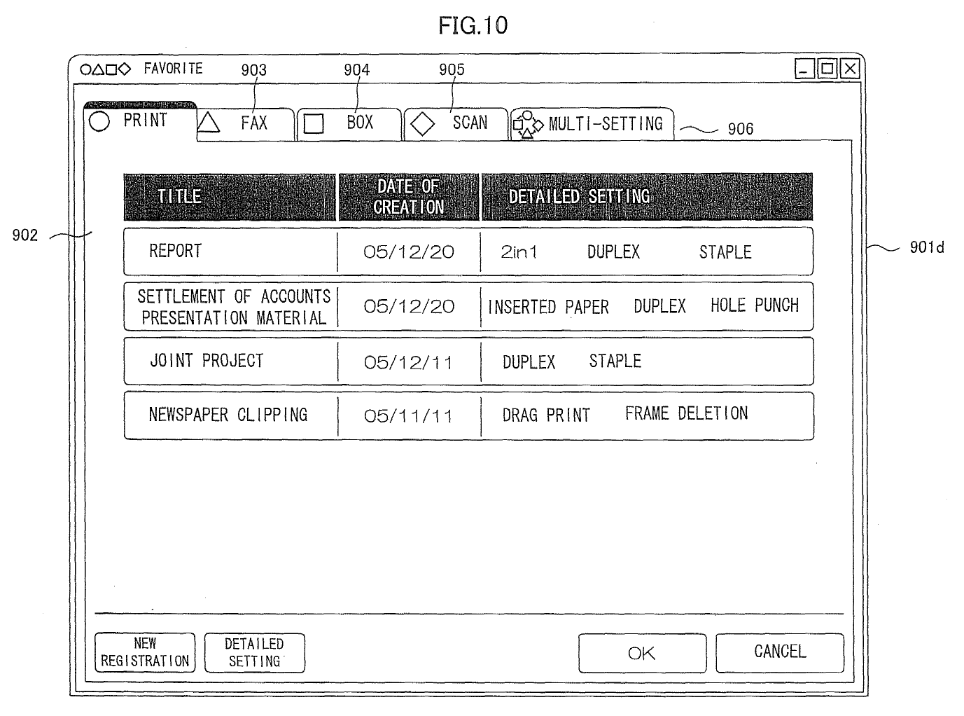

In an example shown in FIG. 10, detailed setting item names specifically indicated as “detailed setting” are equivalent to the “information on the setting items to be set in the setting information”. Here, as a part of the information on the setting items, item names of the setting items to be set are registered in the setting registering unit 103. Contents of specific parameters (e.g., the number of prints, the number of pages allocated to one sheet, etc.) concerning these setting items are not registered. By registering the setting items themselves rather than the contents of the specific setting parameters, it is possible to flexibly perform customization of the setting parameters according to a situation when the registered setting contents are used. As shown in FIG. 10, it is possible to execute setting of the specific setting parameters for the respective setting contents by depressing a “Detailed Setting” button.

It goes without saying that it is possible to easily distinguish the plural setting contents by displaying, as a list, not only the information described as the example above but also information for making it possible to individually identify the setting contents of the favorite settings in the display control unit 108.

In the display control step, information on the setting information to be displayed is allocated to display areas different for each of the functions and displayed therein. It is possible to improve efficiency of search of setting information by grouping the display areas (e.g., tag screens) different for each of the functions to clearly classify and display the display areas on a screen in this way. It goes without saying that it is also possible to adopt an interface for performing plural hierarchical screen displays and vary hierarchies of display screens for each of the functions.

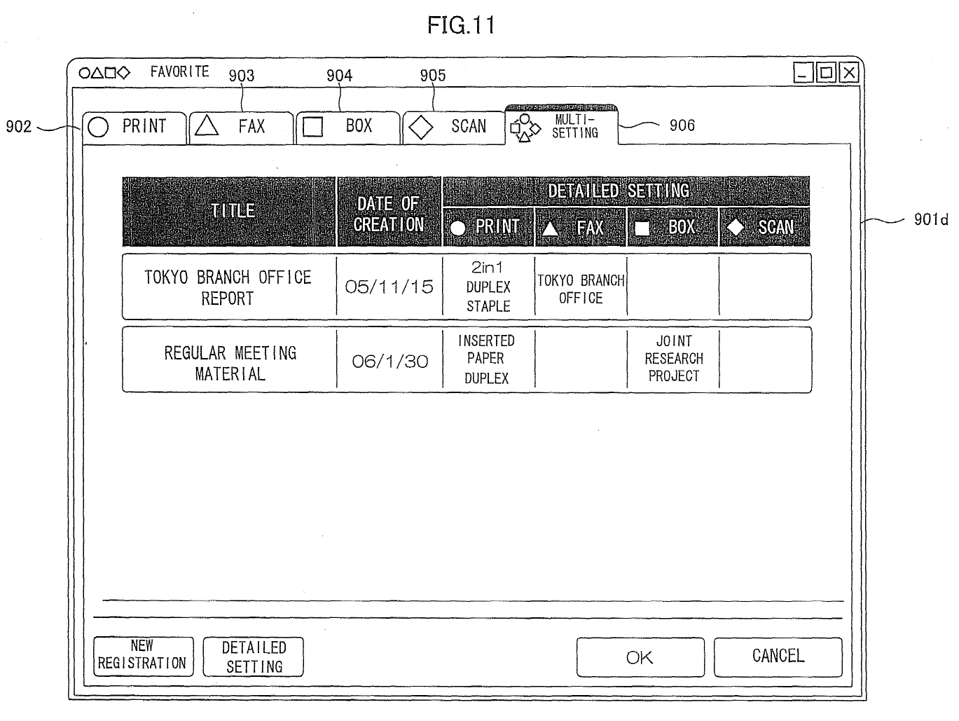

FIG. 10 is a diagram showing a state in which a display screen (a list display screen for the favorite settings) 902 for registered setting contents corresponding to the print function is selected by the user. Besides, by selecting tags corresponding to the “facsimile function”, the “box function”, the “scan function”, and the “multi-setting”, respectively, it is possible to cause, through the display control unit 108, the PC 11 to display a list display screen 903 for setting contents concerning the facsimile function, a list display screen 904 for setting contents concerning the box function, a list display screen 905 for setting contents concerning the scan function, and a list display screen 906 for setting contents concerning the multi-setting. FIG. 11 is a diagram showing an example of the list display screen 906 for registered setting contents corresponding to the multi-setting.

In the function setting screen in the conventional driver apparatus, usually, buttons and the like for performing registration instruction for setting contents are displayed on a top screen common to setting screens for all the functions. On the top screen, for example, only title names and the like of the setting contents can be displayed. Thus, to grasp detailed contents of respective favorite settings, reference screens for the respective setting contents have to be opened and individually confirmed. Therefore, when there are plural settings to which similar titles are given and when there are plural settings with slightly different setting contents, it may be difficult to perform a search.

On the other hand, according to this embodiment, by classifying already registered setting contents (favorite settings) for the respective functions and displaying the setting contents, it is possible to provide a driver screen with which it is easy to intuitively discriminate which function a certain setting content is set for. Further, it is possible to easily grasp a combination of setting items to be set in respective setting contents displayed as a list, prevent a mistake in selection of setting contents, and improve searchability.

In the display control step, it is preferable to rank the information and display the information as a list on the basis of the information acquired in the frequency-information acquiring step such that information on setting contents with a higher frequency of use is located further on at least one of the left side and the upper side in a predetermined display area. Consequently, by searching for setting contents from a higher order position (on the left side or the upper side), the user can easily find out setting contents frequently used. Thus, it is possible to contribute to improvement of searchability for setting contents.

The respective steps in the processing in the driver apparatus are realized by causing the CPU 801 to execute a setting content management program stored in the MEMORY 802.

In this way, in this embodiment, registered items are shown as a list with a tab structure corresponding to the respective functions provided in the image processing apparatus and reduction and addition of information are applied to the registered items. Consequently, it is possible to clarify which function the already registered setting contents are set for, improve visibility, and realize improvement of searchability. Further, it is possible to realize improvement of operability by adopting a screen structure conforming to an operation flow during registration work.

In the embodiment described above, the example in which the processing concerning the display control of the respective setting items on the setting screen is performed on the PC 11 is cited. However, it is also possible to perform the processing, for example, on the image processing apparatus 21. In other words, the image processing apparatus 21 may have functions equivalent to the input accepting unit 101, the instruction requesting unit 102, the setting registering unit 103, the history-information acquiring unit 104, the selected-function determining unit 105, the setting-information acquiring unit 106, the frequency-information acquiring unit 107, the display control unit 108, the display 11a, the operation inputting unit 11b, the CPU 801, and the MEMORY 802.

In the embodiment described above, the example in which the selection, the setting operation, and the like for the driver screens for the respective functions are mainly performed by mouse operation is described. However, the invention is not limited to this. It goes without saying that it is also possible to realize the selection, the setting operation, and the like for the driver screens with an operation input using the keyboard, the touch panel, and the like.

Arbitrary setting contents may be selected from the list of the registered setting contents shown in FIG. 10 and edit the setting contents to create new setting contents.

Besides, when the user errs in attempting to register setting contents for which an identical setting is performed for an identical function, it may be discriminated that there is redundancy in the registered contents in the setting registering unit 103 to cause, through the display control unit 108, the PC 11 to notify to that effect on the basis of a result of the discrimination.

In the explanation of this embodiment, the functions of carrying out the invention are recorded in the apparatus in advance. However, the invention is not limited to this. The same functions may be downloaded from a network to the apparatus or the same functions stored in a recording medium may be installed in the apparatus. As the recording medium, a form of the recording medium may be any form as long as the recording medium is a recording medium that can store a program and is readable by the apparatus such as a CD-ROM. The functions obtained by the installation or the download in advance in this way may be functions realized in cooperation with an OS (Operating System) or the like in the apparatus.

The invention has been explained in detail according to the specific forms. However, it will be apparent to those having ordinary skill in the art that various modifications and alterations may be made without departing from the spirit and the scope of the invention.

As described above in detail, according to the invention, it is possible to provide a technique that can improve visibility of the registered setting contents and contribute improvement of operability in the driver apparatus that causes the image processing apparatus to execute the plural functions executable in the image processing apparatus on the basis of the setting contents registered for the respective functions.

What is claimed is:

1. A driver apparatus that causes an image processing apparatus to execute plural functions executable in the image processing apparatus on the basis of setting contents registered for the respective functions, the driver apparatus comprising:
a selected-function determining unit configured to determine, on the basis of an operation input of a user, a function for which display of the setting contents is requested among the plural functions;
a setting-information acquiring unit configured to acquire setting information indicating the setting contents registered for the function for which it is determined by the selected-function determining unit that display of the setting contents is requested; and
a display control unit configured to cause the image processing apparatus to display, as a list, information on setting information acquired by the setting-information acquiring unit in association with information on the function for which it is determined by the selected-function determining unit that display of the setting contents is requested.

2. A driver apparatus according to claim 1, comprising:
an input accepting unit configured to accept an operation input of a user who performs setting operation for at least any one of the plural functions; and
a setting registering unit configured to register setting information based on the operation input accepted by the input accepting unit.

3. A driver apparatus according to claim 1, wherein the display control unit causes the image processing apparatus to display, as information on the setting information acquired by the setting-information acquiring unit, information on a setting item to be set in the setting information.

4. A driver apparatus according to claim 1, wherein the display control unit allocates information on setting information to be displayed to display areas different for each of the functions and causes the image processing apparatus to display the information therein.

5. A driver apparatus according to claim 1, comprising an instruction requesting unit configured to request the user to give an instruction on whether setting contents of the setting operation accepted by the input accepting unit should be registered, wherein
the setting registering unit registers the setting contents when the instruction to register the setting contents is accepted by the instruction requesting unit.

6. A driver apparatus according to claim 1, comprising a frequency-information acquiring unit configured to acquire information on a frequency of use of the registered setting contents, wherein
the display control unit causes the image processing apparatus to display, on the basis of the information acquired by the frequency-information acquiring unit, information on setting contents with a higher frequency of use further on at least one of a left side and an upper side in a predetermined area.

7. A driver apparatus according to claim 1, comprising a history-information acquiring unit configured to acquire information on a history of the setting operation accepted by the input accepting unit, wherein
the setting registering unit registers, on the basis of the information acquired by the history-information acquiring unit, setting contents for which setting operation with same contents is repeated a predetermined number of times or more.

8. A setting content management method in a driver apparatus that causes an image processing apparatus to execute plural functions executable in the image processing apparatus on the basis of setting contents registered for the respective functions, the setting content management method comprising the steps of:
determining, on the basis of an operation input of a user, a function for which display of the setting contents is requested among the plural functions;
acquiring setting information indicating the setting contents registered for the function for which it is determined in the selected-function determining step that display of the setting contents is requested; and
causing the image processing apparatus to display, as a list, information on setting information acquired by the setting-information acquiring step in association with information on the function for which it is determined in the selected-function determining step that display of the setting contents is requested.

9. A setting content management method according to claim 8, comprising the steps of:
accepting an operation input of a user who performs setting operation for at least any one of the plural functions; and
registering setting information based on the operation input accepted in the input accepting step.

10. A setting content management method according to claim 8, wherein, in the step of causing the image processing apparatus to display information, the image processing apparatus is caused to display, as information on the setting information acquired by the setting-information acquiring step, information on a setting item to be set in the setting information.

11. A setting content management method according to claim 8, wherein, in the step of causing the image processing apparatus to display information, information on setting information to be displayed is allocated to display areas different for each of the functions and the image processing apparatus is caused to display the information therein.

12. A setting content management method according to claim 8, comprising the step of requesting the user to give an instruction on whether setting contents of the setting operation accepted in the input accepting step should be registered, wherein
in the setting-information registering step, the setting contents are registered when the instruction to register the setting contents is accepted in the instruction requesting step.

13. A setting content management method according to claim 8, comprising the step of acquiring information on a frequency of use of the registered setting contents, wherein
in the step of causing the image processing apparatus to display information, the image processing apparatus is caused to display, on the basis of the information acquired in the frequency-information acquiring step, information on setting contents with a higher frequency of use further on at least one of a left side and an upper side in a predetermined display area.

14. A setting content management method according to claim 8, comprising the step of acquiring information on a history of the setting operation accepted in the input accepting step, wherein
in the setting registering step, setting contents for which setting operation with same contents is repeated a predetermined number of times or more are registered on the basis of the information acquired in the history-information acquiring step.

15. A setting content management program for causing a computer to execute management of setting contents in a driver apparatus that causes an image processing apparatus to execute plural functions executable in the image processing apparatus on the basis of setting contents registered for the respective functions, the setting content management program causing the computer to execute:
a selected-function determining step of determining, on the basis of an operation input of a user, a function for which display of the setting contents is requested among the plural functions;
a setting-information acquiring step of acquiring setting information indicating the setting contents registered for the function for which it is determined in the selected-function determining step that display of the setting contents is requested; and
a display control step of displaying, as a list, information on setting information acquired by the setting-information acquiring step in association with information on the function for which it is determined in the selected-function determining step that display of the setting contents is requested.

16. A setting content management program according to claim 15, comprising:
an input accepting step of accepting an operation input of a user who performs setting operation for at least any one of the plural functions; and
a setting registering step of registering setting information based on the operation input accepted in the input accepting step.

17. A setting content management program according to claim 15, wherein, in the display control step, the image processing apparatus is caused to display, as information on the setting information acquired by the setting-information acquiring step, information on a setting item to be set in the setting information.

18. A setting content management program according to claim 15, wherein, in the display control step, information on setting information to be displayed is allocated to display areas different for each of the functions and the image processing apparatus is caused to display the information therein.

19. A setting content management program according to claim 15, comprising an instruction requesting step of requesting the user to give an instruction on whether setting contents of the setting operation accepted in the input accepting step should be registered, wherein
in the setting-information registering step, the setting contents are registered when the instruction to register the setting contents is accepted in the instruction requesting step.

20. A setting content management program according to claim 15, comprising a history-information acquiring step of acquiring information on a history of the setting operation accepted in the input accepting step, wherein
in the setting registering step, setting contents for which setting operation with same contents is repeated a predetermined number of times or more are registered on the basis of the information acquired in the history-information acquiring step.
